(19) United States
(12) Patent Application Publication
(10) Pub. No.: US 2014/0261074 A1
(43) Pub. Date: Sep. 18, 2014

(54) ANTIBACTERIAL PORTLAND CEMENT

(71) Applicant: CIMSA CIMENTO SANAYI VE TICARET ANONIM SIRKETI, Mersin (TR)

(72) Inventor: Tughan Delibas, MERSIN (TR)

(73) Assignee: CIMSA CIMENTO SANAYI VE TICARET ANONIM SIRKETI, MERSIN (TR)

(21) Appl. No.: 14/210,322

(22) Filed: Mar. 13, 2014

(30) Foreign Application Priority Data
Mar. 18, 2013 (TR) 2013/03243

(51) Int. Cl. C04B 24/12; C04B 24/16; C04B 14/00; C04B 24/02

(52) U.S. Cl. CPC C04B 24/121; C04B 24/02; C04B 24/16; C04B 14/00
USPC 106/18.32; 106/18.35

(57) ABSTRACT

The present invention relates to an antibacterial portland cement which essentially comprises clinker (A), gypsum (B), mineral additive (C) and at least one antibacterial agent (D); which is used in every field wherein cement-aggregate-water combination is present together such as tile production, forming construction materials, and which enables the product in which it is used to have resistance against mold, fungus and bacteria.

### FIELD OF THE INVENTION

The present invention relates to an antibacterial Portland cement which is used in every field wherein cement-aggregate-water combination is present together such as tile production, forming construction materials, and enables the product in which it is used to have resistance against mold, fungus and bacteria.

### BACKGROUND OF THE INVENTION

White cement is a special hydraulic binder which sets when combines with water and gains strength as a result of hardening. The main distinctive features of white cement are its raw material being very pure, being produced with advanced technology, being fine grinded, having high strength gain, having aesthetic and decorative features and surface flatness of end products.

The white cement which has been produced for over 100 years and used for usually decorative and aesthetic purposes has also high load bearing capacity.

When compared with grey cement, the white cement having superior performance features is also used in wide range of fields. Some of these fields comprises architectural and decorative concrete productions (trade and business centers, estates, housing constructions, bridges, aesthetic and decorative buildings, stadiums, and the like), premixed plaster and mortar productions, adhesion and joint filling material productions (adhesives and joints for tiles, ceramic tiles and marble granite tiles, and the like), park and garden furniture designs (curbs, flower beds, balcony patterns, concrete columns, benches, boundary stones, concrete grates, parks-gardens arrangement, and the like), art designs (small statues, monuments, sgraffito applications, renovation, relive, murals, reproductions, and the like), floor tile productions (terrazzo type floor tiles in different colors and patterns, thin tiles, wash concrete, parquet, key stone, granolithic plates, and the like), precast element productions and renovations of historical artifacts.

Today, the cements used in different construction productions are also be desired to be used without being spoiled for very long years as well as being strong. In this respect, it is important for human health that the said cement should not keep mold and fungus and should have the feature to protect the structure against bacteria (antibacterial).

### SUMMARY OF THE INVENTION

The objective of the present invention is to provide a triclosan added antibacterial portland cement.

A further objective of the present invention is to provide an antibacterial portland cement which protects human health preventing mold and fungus formation.

### DETAILED DESCRIPTION OF THE INVENTION

The antibacterial portland cement developed to fulfill the objective of the present invention essentially comprises clinker (A), gypsum (B), mineral additive (C) and at least one antibacterial agent (D). Preferably, one or more than one additive facilitating grinding (E) can be added to the composition.

Mineral additive (C) is comprised of at least one of limestone, cinder, silica fume, pozzuolana and cooked schist.

In the preferred embodiment of the invention, triclosan is used as antibacterial agent (D).

In one embodiment of the invention, at least one of the organic compounds of diethanolamine, triethanolamine, triisopropanolamine, aminoethylethanolamine, triethylenetretramine, tetraethylenepentamin and the like is used as grinding facilitating additive (E).

In one embodiment of the inventive cement, there is 20-100% clinker (A), 0-10% gypsum (B), 0-80% mineral additive (C) and 0-10% triclosan (D) present. In the preferred embodiment of the inventive cement, there is 20-100% clinker (A), 0-10% gypsum (B), 0-80% mineral additive (C), 0-10% triclosan (D) amd 0-5 %grinding facilitating additive (E) present.

In the preferred embodiment of the invention, the inventive portland cement is white, and in another embodiment it is grey.

In a method performed to prepare the inventive antibacterial portland cement, all materials are grinded by being fed to ball mill or roller mill. The sizes of the particles in the composition obtained after grinding are below 45 μm.

Consequently, the inventive antibacterial cement comprises triclosan (D) in the range of 0-10% by weight, its strength class is 32.5, 42.5, 52.5; and it can be obtained as portland cement, portland cinder cement, portlant silica fume cement, portland pozzuolana cement, portland fly-ash cement, portland cooked schyst cement, portland limestone cement, portland composite cement or high furnace cinder portland cement according to the mineral additive (C) it comprises.

The inventive cement can be used in construction chemical applications (joint filling, ceramic adhesive, thin and rough cast), terrazzo type floor tiles, parquet stone, pumice, prefabricated concrete elements, cast-in-place concrete, concrete road, tunnel lining, cement based exterior panels, fiberglass reinforced prefabricated exterior panels, natural stone like prefabricated applications, culture stones, and every field wherein cement-aggregate-water combination is used together such as statue.

The inventive antibacterial portland cement prevents mold and fungus formation by means of the triclosan it has, and prolongs the shelf life of the product in which it is used.

1. An antibacterial portland cement for preventing mold and fungus formation, the antibacterial portland cement comprising clinker, gypsum, mineral additive and at least one antibacterial agent, wherein the antibacterial agent is triclosan.

2. The antibacterial portland cement according to claim 1, wherein the antibacterial portland cement is white.

3. The antibacterial portland cement according to claim 1, wherein the antibacterial portland cement is grey.

4. The antibacterial portland cement according to claim 1, wherein the mineral additive comprises at least one of the following group: limestone, cinder, silica fume, fly ash, pozzuolana and cooked schist.

5. The antibacterial portland cement according to claim 1, further comprising grinding facilitating additive.

6. The antibacterial portland cement according to claim 5, wherein the grinding facilitating additive comprises at least one of the following organic compounds: diethanolamine, triethanolamine, triisopropanolamine, aminoethylethanolamine, triethylenetretramine and tetraethylenepentamin.

7. The antibacterial portland cement according to claim 1, wherein the antibacterial portland cement comprises 20-100% of the clinker, 0-10% of the gypsum, 0-80% of the mineral additive and 0-10% of the triclosan by weight.

8. The antibacterial portland cement according to claim 1, wherein the particle diameter of the antibacterial portland cement is below 45 μm.

9. The antibacterial portland cement according to claim 5, wherein the antibacterial portland cement comprises 20-100% of the clinker, 0-10% of the gypsum, 0-80% of the mineral additive, 0-10% of the triclosan and 0-5% of the grinding facilitating additive by weight.
